(19) United States
(12) Patent Application Publication
(10) Pub. No.: US 2014/0265183 A1
(43) Pub. Date: Sep. 18, 2014

(54) STRAWBERRY BOX CART WITH WORKER SUPPORT

(71) Applicant: Dario Grossberger, Camarillo, CA (US)

(72) Inventor: Dario Grossberger, Camarillo, CA (US)

(21) Appl. No.: 13/802,013

(22) Filed: Mar. 13, 2013

(51) Int. Cl. A01D 46/24

(52) U.S. Cl. CPC A01D 46/243
USPC 280/32.5

(57) ABSTRACT

A strawberry box cart. The strawberry box cart includes a cart surface, where the cart surface is configured to support a strawberry box. The strawberry box cart also includes two or more wheels, where the one or more wheels are configured to support the weight of the strawberry box cart. The strawberry box cart further includes means for maintaining the wheels within furrows in a strawberry field. The strawberry box cart additionally includes a worker support configured to support at least a portion of a body of a worker.

### CROSS-REFERENCE TO RELATED APPLICATIONS

Not applicable.

### BACKGROUND OF THE INVENTION

Picking strawberries can be a difficult and arduous task. Most of the time, picking is done by hand by workers on foot. The workers pick the strawberries and place them in boxes of standardized size so the boxes can be stacked on top of one another. The workers get an empty box from the end of the field row or other collection point, walk it to where they need to pick, fill the box, and then return it to the collection point. Consequently, the worker spends a significant portion of his/her time moving boxes back and forth; time which cannot be spent picking strawberries.

In addition, the worker has to bend over to pick the strawberries. I.e., because strawberries grow low to the ground, the worker has to either squat down or bend over when picking the strawberries. This can lead to knee and/or back problems for the worker. Thus, time is lost allowing workers to recover from this strain and workers can suffer serious knee and back problems over time.

Strawberry box carts have been conceived but they are neither widely used nor widely available. This is because the strawberry box carts have a number of drawbacks. In particular, they provide a space for the worker, but they do not increase the worker's efficiency. No provision is made for collection of filled boxes or distribution to the worker of unfilled boxes. When a box is filled, a worker must still take the box to the end of the row and retrieve an empty box which can likewise be filled. Therefore, the amount of time moving boxes to and from collection points is not reduced.

The workers could use existing wheeled devices, such as wheelbarrows, garden cars, works trucks and the like, to assist in the strawberry picking. However, these devices suffer a number of drawbacks. In particular, they are not sized to work well in strawberry fields. In particular, strawberry fields include wide rows. These devices would therefore have to be driven directly over the strawberry plants and damage the plants and fruit. Further, they do not allow the worker to pick strawberries in a more comfortable position and do not reduce the amount of strain to the worker's joints. Further, these devices cannot hold enough filled boxes to save the worker from taking filled boxes to collection points while working a row. I.e., when the box is full, a worker must move the box to the end of the row and retrieve an empty box which can likewise be filled. Therefore, the amount of time moving boxes to and from collection points is not reduced.

Additionally, automated means for picking strawberries exist; however, they are not widely available. In particular, the automated means generally damage the strawberries, are inefficient, or are too expensive. Therefore, automated means of harvesting strawberries are not widely used.

Accordingly, there is a need in the art for a strawberry picking strawberry box cart that can be moved by the worker while in position to harvest the strawberries. In addition, there is a need in the art for the strawberry box cart to allow the worker to quickly store full strawberry boxes and place an empty strawberry box in position for picking. Further, there is a need in the art for a strawberry box cart that can reduce the number of trips to collection points. Additionally, there is a need in the art for a strawberry box cart that allows the worker to keep his/her hands free while picking strawberries.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a strawberry box cart. The strawberry box cart includes a cart surface, where the cart surface is configured to support a strawberry box. The strawberry box cart also includes two or more wheels, where the one or more wheels are configured to support the weight of the strawberry box cart. The strawberry box cart further includes means for maintaining the wheels within furrows in a strawberry field. The strawberry box cart additionally includes a worker support configured to support at least a portion of a body of a worker.

Another example embodiment includes a strawberry box cart. The strawberry box cart includes a cart surface, where the cart surface is configured to support a strawberry box. The strawberry box cart also includes two or more wheels, where the one or more wheels are configured to support the weight of the strawberry box cart. The strawberry box cart further includes means for maintaining the wheels within furrows in a strawberry field. The strawberry box cart additionally includes a push bar, where the push bar is configured to allow the user to move the strawberry cart using the wheels. The strawberry box cart moreover includes a worker support configured to support at least a portion of a body of a worker.

Another example embodiment includes a strawberry box cart. The strawberry box cart includes two front wheels, where each front wheel is connected to a front axle on the strawberry box cart. The strawberry box cart also includes two rear wheels, where each rear wheel is connected to a rear axle on the strawberry box cart. The front wheel axles and the rear wheel axles are configured to support the weight of the strawberry box cart. The strawberry box cart further includes a cart surface, where the cart surface is configured to support a strawberry box. The strawberry box cart additionally includes a wheel guide on each of the two front wheels and each of the two rear wheels, where the wheel guide is configured to maintain the wheels within furrows in a strawberry field. The strawberry box cart moreover includes a push bar, where the push bar is configured to allow the user to move the strawberry cart using the wheels. The strawberry box cart also includes a worker support configured to support at least a portion of a body of a worker.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1A illustrates a side view of an example of a strawberry bed with a 48 inch bed;

FIG. 1B illustrates a side view of an example of a strawberry bed with a 24 inch bed;

FIG. 1C illustrates a top view of an example of a strawberry bed with a 48 inch bed;

FIG. 1D illustrates a top view of an example of a strawberry bed with a 24 inch bed;

FIG. 2A illustrates a front view of the strawberry box cart;

FIG. 2B illustrates a side view of the strawberry box cart;

FIG. 2C illustrates a top view of the strawberry box cart; and

FIG. 2D illustrates a side view of the strawberry box cart with a worker and strawberry bed shown.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

FIGS. 1A, 1B, 1C and 1D illustrate an example of a strawberry bed 100. FIG. 1A illustrates a side view of an example of a strawberry bed 100 with a 48 inch bed; FIG. 1B illustrates a side view of an example of a strawberry bed 100 with a 24 inch bed; FIG. 1C illustrates a top view of an example of a strawberry bed 100 with a 48 inch bed; and FIG. 1D illustrates a top view of an example of a strawberry bed 100 with a 24 inch bed. The strawberry bed 100 can be used for growing strawberry plants 102. In particular, the strawberry bed 100 can be used to raise the strawberry plants 102 so workers need not bend over as far and also to ensure that, as strawberries grow, water can be applied and the strawberry grower or workers can move among the strawberries without damaging the plants 102 or fruit. One of skill in the art will appreciate that while strawberry plants 102 and strawberry harvesting are treated as exemplary, the embodiments described herein can be used for growing and harvesting any ground level plants and fruits.

FIGS. 1A, 1B, 1C and 1D show that the strawberry bed 100 with strawberry plants 102 includes a furrow 104. In at least one implementation, the furrow 104 can include an area where no strawberry plants 102 are allowed to grow. In particular, the floor of the furrow 104 can remain clear to allow for movement among the strawberry plants 102. For example, water can be added to the furrow 104, which moves through the furrow 104 in order to water the strawberry plants 102. Additionally or alternatively, a person or machine can be moved through the strawberry bed 100 with all parts in contact with the ground located on the floor of furrow 104. The parts in contact with the ground will, therefore, not damage the strawberry plants 102 or the fruit growing thereon.

FIGS. 1A, 1B, 1C and 1D further show that the strawberry bed 100 can include a planting bed 106. In at least one implementation, the planting bed 106 can include a raised area where the strawberry plants 102 are located. In particular, the raised area is protected because machines and people move through the furrow 104.

In at least one implementation, the dimensions of the width between troughs 104 and the width of the row 106 can be standardized. Standardization may have any basis, including production efficiency, state or local regulations, an agreement between farmers, a standard size of farm machinery or any other basis. For example, standardization can include a trough 18 inches wide and a row 48 inches wide. I.e., the distance between adjacent furrows 104 can be 66 inches. Additionally or alternatively, standardization can include a trough 18 inches wide and a row 24 inches wide. I.e., the distance between adjacent furrows 104 can be 42 inches. One of skill in the art will appreciate that after creation of the furrow 104 and the planting bed 106, erosion will cause the sides of the furrow 104 to become slanted rather than vertical.

FIGS. 2A, 2B, 2C and 2D illustrate an example of a strawberry box cart 200. FIG. 2A illustrates a front view of the strawberry box cart 200; FIG. 2B illustrates a side view of the strawberry box cart 200; FIG. 2C illustrates a top view of the strawberry box cart 200; and FIG. 2D illustrates a side view of the strawberry box cart 200 with a worker 202 and strawberry bed shown 100. In at least one implementation, the strawberry box cart 200 can be used to harvest strawberries or other ground growing fruit. In particular, the strawberry box cart 200 can allow the worker 202 to harvest strawberries without being forced to bend over or otherwise strain themselves. Harvesting can continue for long periods of time during a harvest day; therefore, reducing the strain on the worker 202 can allow for a more productive day of harvesting and reduce time lost to allowing the worker 202 to recover.

FIGS. 2A, 2B, 2C and 2D show that the strawberry box cart 200 can include one or more wheels 204. In at least one implementation, the wheels 204 can allow the strawberry box cart 200 to move through strawberry beds. For example, if the centers of adjacent furrows are 66 inches apart, the wheels 204 can be spaced 66 inches apart side to side. Spacing the wheels 204 side to side the same distance as the space between furrows can ensure that as the strawberry box cart 200 moves through a strawberry bed, the wheels 204 remain in the furrows rather than damaging the strawberry plants.

FIGS. 2A, 2B, 2C and 2D further show that the strawberry box cart 200 can include a wheel guide 206. In at least one implementation, the wheel guide 206 can help keep the strawberry box cart 200 within the furrows when working in a strawberry bed. In particular, the wheel guide 206 can abut against the sides of the furrows to keep the wheels in the furrow; therefore, the strawberry box cart will naturally position itself in the furrows, as described below.

FIGS. 2A, 2B, 2C and 2D also show that the strawberry box cart 200 can include a platform 208. In a least one implementation, a box 210 can be placed on the platform 208. I.e., the platform 208 can be used to store boxes 210 while awaiting fruit and after picking for movement to the ends of rows.

FIGS. 2A, 2B, 2C and 2D further show that the strawberry box cart 200 can include one or more push bars 212. In at least one implementation, the one or more push bars 212 can be used to move the platform 208 laterally, as needed. In particular, the one or more push bars 212 can allow the worker 202 to position the platform 208, and a box 210 located thereon if present, into the most convenient position for placing the fruit, as described below.

FIGS. 2A, 2B, 2C and 2D further show that the strawberry box cart 200 can include a first worker position 214a and a second worker position 214b (collectively “worker positions 214”). The worker positions 214 can allow a worker 202 to comfortably pick strawberries from the strawberry plants 102 for long periods of time. For example, a worker 202 in worker position 214a could pick from rows 1a and 2a in FIG. 1C and a worker 202 in position 214b could pick from rows 1b and 2b in FIG. 1C.

FIGS. 2A, 2B, 2C and 2D further show that the strawberry box cart 200 can include a worker support 216. The worker support 216 can support at least a portion of a body of the worker 202 while harvesting. I.e., the worker support 216 can allow the worker 202 to be in a comfortable position while working, allowing the worker 202 to be more productive for longer periods of time.

FIGS. 2A, 2B, 2C and 2D show that the worker support 216 can include a chest cushion 218. In at least one implementation, the chest cushion 218 can include a pad on which the worker 202 can support his/her chest and/or stomach. I.e., the chest cushion 218 can support the trunk of the body of the worker 202. The chest worker support 216 can allow a high range of movement even while supporting the weight of the worker 202, as described below. In particular, the chest cushion 218 can allow a worker 202 to remain in the strawberry box cart 200 while supporting his/her body in a comfortable position, which reduces the strain on the body of the worker 202. For example, the chest cushion 218 can allow the worker 202 to lie in a prone position or a semi-prone position; i.e., a face-down position that is substantially horizontal or that is inclined.

FIGS. 2A, 2B, 2C and 2D further show that the worker support 216 can include a head cushion 220. In at least one implementation, the worker 202 can rest his/her head on the head cushion 220. In particular, the head cushion 220 can work with the chest cushion 218 to prevent neck and back strain to the worker 202. Additionally or alternatively, the head cushion 220 can allow the worker 202 to continually observe the strawberry plants in order to look for pickable fruit.

FIGS. 2A, 2B, 2C and 2D further show that the worker support 216 can include a height adjustment 222. The height adjustment 222 can allow a worker 202 to adjust the height of a portion of the worker support 216 to maximize the comfort of the worker 202. For example, the height adjustment 222 can allow the worker 202 to change the height of the chest cushion 218, the head cushion 220 or any other desired portions of the worker support 216.

FIGS. 2A, 2B, 2C and 2D further show that the worker support 216 can include an angle adjustment 224. The angle adjustment 224 can allow a worker 202 to adjust the angle of a portion of the worker support 216 to maximize the comfort of the worker 202. For example, the angle adjustment 224 can allow the worker 202 to adjust the angle of portions of the worker support 216 relative to one another, to the platform 208 or to other portions of the strawberry cart 200.

FIGS. 2A, 2B, 2C and 2D further show that the strawberry box cart 200 can include one or more boxes 210. In at least one implementation, the one or more boxes 210 can be configured to hold the picked strawberries. The one or more boxes 210 can stack on one another for stability. Additionally or alternatively, the one or more boxes 210 can be moved into any desired position on the strawberry box cart 200 to be filled by the worker 202 or stored for transport to a collection point. For example, the boxes 210 can be placed on the platform 208 until the boxes 210 can be removed.

FIGS. 2A, 2B, 2C and 2D also show that the strawberry box cart 200 can include a box platform 226. In at least one implementation, the box platform 226 can be used to store boxes 210 in a manner that allows the worker 202 to easily place picked fruit in one or more boxes 210. Additionally or alternatively, the box platform 226 can move, as indicated by the double sided arrows, to be placed in the most convenient position for the worker 202.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A strawberry box cart, the strawberry box cart comprising:
a cart surface, wherein the cart surface is configured to support a strawberry box;
two or more wheels, wherein the one or more wheels are configured to support the weight of the strawberry box cart;
means for maintaining the wheels within furrows in a strawberry field; and
a worker support configured to support at least a portion of a body of a worker.

2. The strawberry box cart of claim 1 wherein the worker support includes a chest cushion.

3. The strawberry box cart of claim 1 wherein the worker support includes a head cushion.

4. The strawberry box cart of claim 1 wherein the worker support includes a height adjustment.

5. The strawberry box cart of claim 1 wherein the worker support includes a angle adjustment.

6. The strawberry box cart of claim 1, wherein the means for maintaining the wheels within furrows in a strawberry field includes a wheel guide.

7. The strawberry box cart of claim 1 wherein the means for maintaining the wheels within furrows in a strawberry field is configured to abut against a side of the furrow.

8. The strawberry box cart of claim 1, wherein the means for maintaining the wheels within furrows in a strawberry field includes:
a first wheel guide on first wheel of the two or more wheels; and
a second wheel guide on a second wheel of the two or more wheels.

9. The strawberry box cart of claim 1 further comprising a push bar.

10. A strawberry box cart, the strawberry box cart comprising:
a cart surface, wherein the cart surface is configured to support a strawberry box; and
two or more wheels, wherein the one or more wheels are configured to support the weight of the strawberry box cart;
a wheel guide configured to maintain the wheels within furrows in a strawberry field;
a push bar, wherein the push bar is configured to allow the user to move the strawberry cart using the wheels; and
a worker support configured to support at least a portion of a body of a worker.

11. The strawberry box cart of claim 10, wherein the push bar includes a hinge, wherein the hinge allows a user to change the position of the push bar relative to the cart surface.

12. The strawberry box cart of claim 10, wherein the hinge allows a user to change the position of the push bar relative to the cart surface between a vertical position and a horizontal position.

13. The strawberry box cart of claim 12, wherein the vertical position is configured to allow a user to apply a motive force to the strawberry cart.

14. The strawberry box cart of claim 12, wherein the horizontal position is configured to allow access to the cart surface.

15. The strawberry box cart of claim 12 further comprising a box platform.

16. The strawberry box cart of claim 15, wherein the box platform is configured to move relative to the cart surface.

17. A strawberry box cart, the strawberry box cart comprising:
two front wheels, wherein each front wheel is connected to a front axle on the strawberry box cart;
two rear wheels, wherein each rear wheel is connected to a rear axle on the strawberry box cart;
wherein the front wheel axles and the rear wheel axles are configured to support the weight of the strawberry box cart;
a cart surface, wherein the cart surface is configured to support a strawberry box;
a wheel guide on each of the two front wheels and each of the two rear wheels, wherein the wheel guide is configured to maintain the wheels within furrows in a strawberry field; and
a push bar, wherein the push bar is configured to allow the user to move the strawberry cart using the wheels; and
a worker support configured to support at least a portion of a body of a worker.

18. The strawberry box cart of claim 17, wherein the distance between the front wheels is 66 inches.

19. The strawberry box cart of claim 18, wherein the distance between the two front wheels is 42 inches.
